(19) United States
(12) Patent Application Publication
(10) Pub. No.: US 2026/0120667 A1
(43) Pub. Date: Apr. 30, 2026

(54) DYNAMIC CHUNKING FOR SOUNDS FROM AUTOMOTIVE INPUTS

(71) Applicant: William Adams, Los Angeles, CA (US)

(72) Inventor: William Adams, Los Angeles, CA (US)

(21) Appl. No.: 19/008,329

(22) Filed: Jan. 2, 2025

Related U.S. Application Data
(63) Continuation-in-part of application No. 18/337,017, filed on Jun. 18, 2023.
(60) Provisional application No. 63/354,174, filed on Jun. 21, 2022.
(60) Provisional application No. 63/428,376, filed on Nov. 28, 2022.
(60) Provisional application No. 63/440,879, filed on Jan. 24, 2023.
(60) Provisional application No. 63/447,265, filed on Feb. 21, 2023.
(60) Provisional application No. 63/617,716, filed on Jan. 4, 2024.
(60) Provisional application No. 63/632,464, filed on Apr. 10, 2024.
(60) Provisional application No. 63/733,180, filed on Dec. 12, 2024.

(51) Int. Cl. G10H 1/00

(52) U.S. Cl. CPC G10H 1/0025; G10H 2210/091; G10H 2210/131; G10H 2210/301

(57) ABSTRACT

A computer system for manipulating, combining, or composing dynamic sounds accesses a package of one or more music stems. The computer system then receives an input variable from one or more vehicle sensors. The one or more vehicle sensors measure an aspect of driving parameters of a vehicle. In response to the input variable, the computer system generates a particular audio effect with the one or more music stems.

### CROSS-REFERENCE TO RELATED APPLICATIONS

This application claims the benefit of and priority to: 1) U.S. Provisional Patent Application Ser. No. 63/733,180 filed on 12 Dec. 2024 and entitled “DYNAMIC SOUNDS FROM AUTOMOTIVE INPUTS,” 2) U.S. Provisional Patent Application Ser. No. 63/632,464 filed on 10 Apr. 2024 and entitled “DYNAMIC SOUNDS FROM AUTOMOTIVE INPUTS,” and 3) U.S. Provisional Patent Application Ser. No. 63/617,716 filed on 4Jan. 2024 and entitled “DYNAMIC SOUNDS FROM AUTOMOTIVE INPUTS.” The entire contents of each of the aforementioned applications are incorporated herein by reference in their entireties.

This is also a continuation-in-part of U.S. application Ser. No. 18/337,017 filed on Jun. 18, 2023 and entitled “DYNAMIC SOUNDS FROM AUTOMOTIVE INPUTS,” which application claims the benefit of and priority to: 1) U.S. Provisional Patent Application Ser. No. 63/447,265 filed on 21 Feb. 2023 and entitled “DYNAMIC SOUNDS FROM AUTOMOTIVE INPUTS,”2) U.S. Provisional Patent Application Ser. No. 63/440,879 filed on 24 Jan. 2023 and entitled “AI GENERATED SOUNDS FROM AUTOMOTIVE INPUTS,” 3) U.S. Provisional Patent Application Ser. No. 63/428,376 filed on 28 Nov. 2022 and entitled “AI GENERATED SOUNDS FROM AUTOMOTIVE INPUTS,” and 4) U.S. Provisional Patent Application Ser. No. 63/354,174 filed on 21 Jun. 2022 and entitled “AI GENERATED SOUNDS FROM AUTOMOTIVE INPUTS.” The entire contents of each of the aforementioned applications and/or patents are incorporated by reference herein in their entirety.

### BACKGROUND

In recent years, the popularity of music streaming services has grown significantly. Users now have access to vast music libraries, allowing them to stream their favorite songs anytime, anywhere. Most music services now provide users with customized selections of music. The user may request that a completely custom playlist of music be played, or the user may request a particular genre or type of music. A music service can then wholly or partially generate a list of music that has been selected based upon the user's previously identified preferences.

Accordingly, modern music services can provide users with a custom music experience. These experiences are driven by a collection of software, including artificial intelligence, that carefully gather information about a user's musical tastes and curate musical experiences based upon this information. The ability to use technology to map music and sound to a user provides significant benefits to the user's musical experience.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Disclosed embodiments include a computer system for manipulating, combining, or composing dynamic sounds. The computer system accesses a package of one or more music stems. The computer system then receives an input variable from one or more vehicle sensors. The one or more vehicle sensors measure an aspect of driving parameters of a vehicle. In response to the input variable, the computer system generates a particular audio effect with the one or more music stems.

In some aspects, the techniques described herein relate to a computer system for dynamic chunking for sounds from automotive inputs at a vehicle, including: one or more processors; and one or more computer-readable media having stored thereon executable instructions that when executed by the one or more processors configure the computer system to: receive a digital audio file for a particular song; process the digital audio file into a plurality of stems and sections, wherein: each stem represents a separate component or element of a song, and each section includes a continuous portion of the song; number the sections in a priority sequence; associate the stems from the sections to input variables from one or more vehicle sensors; and generate a digital data packet that includes one or more stems, one or more sections, and associations to input variables from one or more vehicle sensors.

In some aspects, the techniques described herein relate to a computer-implemented method for dynamic chunking for sounds from automotive inputs at a vehicle, executed on one or more processors, the computer-implemented method includes: receiving a digital audio file for a particular song; processing the digital audio file into a plurality of stems and sections, wherein: each stem represents a separate component or element of a song, and each section includes a continuous portion of the song; number the sections in a priority sequence; associating the stems from the sections to input variables from one or more vehicle sensors; and generating a digital data packet that includes one or more stems, one or more sections, and associations to input variables from one or more vehicle sensors.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings described below.

FIG. 1 illustrates a schematic diagram of a computer system for AI generated sounds from automotive inputs.

FIG. 2 illustrates a schematic diagram of a roadway and a vehicle.

FIG. 3 illustrates a flow chart of a method for generating AI generated sounds from automotive inputs.

FIG. 4 illustrates a user interface for generating AI generated sounds from automotive inputs.

FIG. 5 illustrates another user interface for generating AI generated sounds from automotive inputs.

FIG. 6 illustrates example stems divided into sections.

FIG. 7 illustrates a schematic of an example audio engine for managing the chunking of a digital audio file.

FIG. 8 illustrates a schematic of an example audio graph.

FIG. 9A illustrates a schematic of an example update process for chunking a digital audio file.

FIG. 9B illustrates a schematic of another example update process for chunking a digital audio file.

FIG. 10 illustrates a schematic of an example of an audio block view table buffer.

FIG. 11 illustrates a flowchart for a method of dynamic chunking for sounds from automotive inputs at a vehicle.

### DETAILED DESCRIPTION

Disclosed embodiments include a computer system for combining, manipulating, or composing dynamic sounds. The computer system receives input variables from vehicle sensors. In response to the input variable, the system generates, combines, and/or manipulates particular sounds that are mapped to the input variables. For example, as a driver travels down a road or highway, the user's speed, braking, turning, reversing and other vehicular actions can be used to create a unique soundtrack that matches the driving experience.

Disclosed embodiments allow a driver to create a custom soundscape that connects the driver, the vehicle, and the driving environment. As used herein, a “soundscape” comprises any recording of an audio composition, or soundtrack, that dynamically adjusts to the driving of the vehicle. The driver is able to wholly or partially create a custom soundscape that is at least in part based upon sensor readings (i.e., input variables) from the vehicle sensors. As used herein, the vehicle sensors may include sensors such as, but not limited to, steering sensors, suspension sensors, IMU sensors, gyroscopes, accelerometers, speed sensors, acceleration sensors, gears sensors, braking sensors, GPS sensors, temperature sensors, clocks, rain sensors, odometers, weather data, and any other common vehicle sensor. In at least one embodiment, vehicle sensors may include sensors that are not integrated within the vehicle itself, such as a GPS sensor within a mobile phone that communicates GPS coordinates of the mobile phone, and hence the vehicle, to the computer system. The combination of one or more sensors can be leveraged to create a custom soundscape that is responsive to the driver and the area that the vehicle is traveling through.

### I. Computer System for Dynamically Generated Sounds From Automotive Inputs

Disclosed embodiments include an AI system that utilizes input variables, such as navigation route, speed, time, location, etc., from vehicle sensors to generate or manipulate audio compositions in real time. As such, in some embodiments a driver performs the function of a D.J. or even a composer of a unique piece of music or soundscape based on how, where, and when the driver drives the vehicle. Similarly, the vehicle becomes an ecosystem for new creative experiences. In at least one embodiment, drivers are able to publish their created soundscapes on other platforms for other people to consume and/or purchase.

The driver may select a particular base-song, stems, or stem that the user manipulates through their driving. For example, as the user accelerates, the base-song or stems may speed up or increase in volume. In contrast, as the user presses the brakes the base-song or stems may decrease in speed or volume. Similarly, in at least one embodiment, as a user accelerate or decelerates, the computer may apply or remove one or more filters from the base-song or stems. As such, the user may be able to select a popular song, such as OMG by Will.i.am. The user may then be able to “customize” or otherwise manipulate the song in real-time based upon the user's driving of the vehicle. Specifically, the song or stems may be manipulated to reflect the user's feelings based upon how the user is driving the vehicle or other related information.

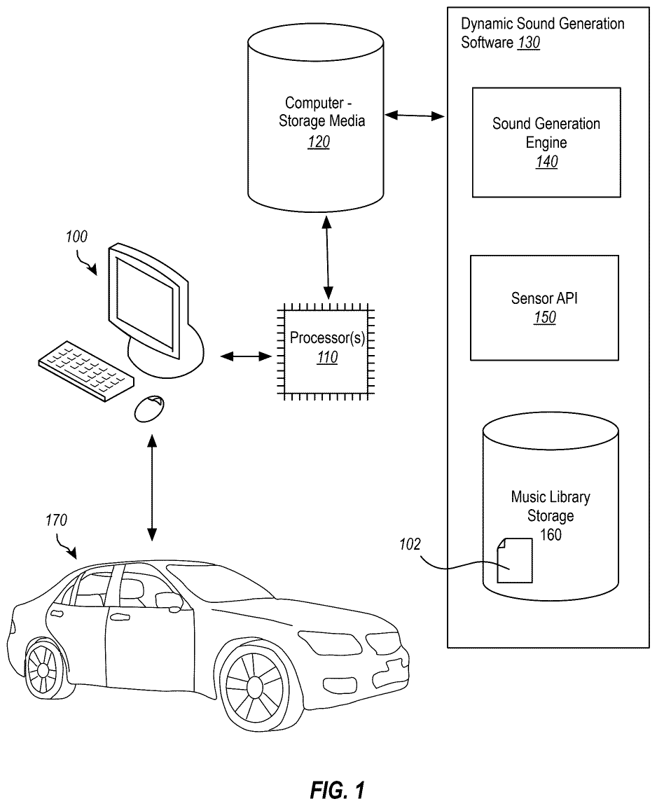

FIG. 1 illustrates a schematic diagram of a computer system 100 for AI generated sounds from automotive inputs. The computer system 100 comprises one or more processors 110 and computer-storage media 120. The computer-storage media 120 stores computer-executable instructions that when executed cause the computer system 100 to perform various actions. For example, the computer-executable instructions may comprise instructions for a Dynamic Sound Generation Software 130 application.

The Dynamic Sound Generation Software 130 application comprises a Sound Generation Engine 140, Sensor API 150, and a Music Library Storage 160. In at least one embodiment, the disclosed system can intelligently generate any aspect of a soundscape including the melody, rhythm, tempo, and various audio effects. The audio from a journey may be generated in real time, and played on vehicle speakers in real time, becoming an integral part of the driving experience. The audio can also be saved as a file for playback later. The audio may also be uploaded to a social media platform and/or marketplace for other users to consume and experience.

As used herein, an “engine” comprises computer executable code and/or computer hardware that performs a particular function. One of skill in the art will appreciate that the distinction between different engines is at least in part arbitrary and that engines may be otherwise combined and divided and still remain within the scope of the present disclosure. As such, the description of a component as being a “engine” is provided only for the sake of clarity and explanation and should not be interpreted to indicate that any particular structure of computer executable code and/or computer hardware is required, unless expressly stated otherwise. In this description, the terms “component”, “agent”, “manager”, “service”, “module”, “virtual machine” or the like may also similarly be used.

In at least one embodiment, the Sound Generation Engine 140 comprises an artificial intelligence algorithm, machine learning algorithm, neural network, or some other appropriate algorithm that may be used to synthesize a soundtrack from the various sensor inputs received from the driver's vehicle 170. The Sound Generation Engine 140 may receive sensor inputs from a Sensor API 150. The Sensor API 150 may be configured to receive sensor data from vehicle sensors.

As the Sound Generation Engine 140 generates a soundscape, the Sound Generation Engine 140 may utilize information from both the Sensor API 150 and the Music Library Storage 160. For example, the Music Library Storage 160 may include acoustic profiles of different types of instruments, different genres, different songs, different song samples, different individual stems, and/or different group stems. Additionally, the Dynamic Sound Generation Software 130 application may store the custom created soundtracks in the Music Library Storage 160 as the driver composes soundscapes.

In at least one embodiment, one or more portions of the dynamic sound generation software 130 may be distributed between multiple different processors in multiple different locations. For example, in at least one embodiment, a portion of the dynamic sound generation software 130 is hosted in the cloud such that multiple different vehicles communicate to the cloud-hosted portion. Similarly, portions of the dynamic sound generation software 130 may be hosted by each of the multiple different vehicles.

In at least one embodiment, the dynamic sound generation software 130 may comprise a music store that allows users to download and/or upload songs, stems, and other soundscape components. For instance, users may be allowed to purchase a number of different stems that a driver can select between and/or mix together in order to create a desired soundscape. The stems, songs, or other soundscape components may be stored locally at the vehicle once purchased. In contrast, in some embodiments the stems, songs, or other soundscape components are stored in the cloud and downloaded as needed by the vehicle 170.

In at least one embodiment, some stems, songs, or other soundscape components are made available only at specific destinations, times, after specific actions by the user, and/or under some other particular set of circumstances. For example, a particular stem may be available to the driver only if the driver passes a particular eating establishment at noon. Similarly, a particular soundscape may only become available to a driver once the driver has driven more than 100,000 miles in the vehicle 170. As a further example, a particular song may only become available if the driver is driving in the snow. Once available, the stems, songs, or other soundscape components may be automatically downloaded to the vehicle 170, automatically downloaded to the driver's cloud storage, and/or presented to the user as an optional download.

In some embodiments, users may be able to purchase stems, songs, or other soundscape components from the user's mobile phone or computer. Additionally or alternatively, the users may be able to purchase the stems, songs, or other soundscape components from a user interface integrated into the vehicles entertainment system. In either case, once purchased the user may be able to manipulate and use the purchased stems, songs, or other soundscape components.

### II. Sensors and Data for Input to Sound Generation Engine

Any movement or parameter received from a vehicle sensor may affect the composition of the soundscape. The Sensor API 150 may receive data from vehicle sensors that include, but are not limited to, turns, speed, acceleration and deceleration, route taken, brake movements, gear shifting and changing, forward and reverse movements, sonar, radar, recuperation, and any other mechanical movements of the car. The Sensor API 150 may also receive any data from vehicle sensors related to the vehicle 170 or driving experience which may include, but are not limited to, time and duration of the journey, weather conditions, environmental conditions, traffic conditions, location, origin and destination of the journey, the characteristics of the driver and passengers, the make and model of the vehicle itself, and other vehicle-specific characteristics. In at least one embodiment, the Sensor API 150 may receive input variables from gyroscopes and accelerometers integrated within the vehicle 170. For example, input variables from a gyroscope may provide a better soundscape experience than input variables from a steering wheel because a driver cranking on a steering wheel to park may not be reflective of the actual physical feeling of turning within the vehicle 170. In such a case, a gyroscope may provide a better input variable.

In at least one embodiment, the composition of a soundscape may be customized to a particular driver based upon information about the driver. A driver may create a user profile and/or a user profile may be created over time for a drive. For example, drivers may appreciate particular genres of music, intensities of music, types of instruments, particular performers, loudness of the music, eras of music, and various other classifications and characteristics of music. In some embodiment, a user's sound and music preferences can be gathered from pre-existing data about the user, such as the user's playlists or music listening history. Additionally, a server may be able to track the musical tastes of individuals over time and location. For example, the server may indicate that user's prefer different music/sound when driving in the forest versus when driving in a desert, or when driving in the rain versus driving on a sunny day. The resulting music/sound composition may be adjusted to reflect these differences.

In at least one embodiment, the Sensor API 150 may receive data from vehicle sensors that includes one or more of the following example sources: acceleration, GPS, AI Voice, Front Sonar/Radar, Rear Sonar/Radar, and/or Vibration in seats. In additional or alternative embodiments, the Sound Generation Engine 140 may map particular sensors to specific audio parameters. For instance, accelerating in the vehicle 170 may be mapped to an audio/patch/preset sound. The brake pedal may be mapped to an audio release/decay/patch/preset sound. The steering wheel may be mapped to an envelope/filter/patch/preset sound. The suspension may be mapped to an LFO/patch/preset sound. The speedometer may be mapped to an arpeggiation/patch/preset sound that is activated after reaching a specific speed.

In at least one embodiment, each stem, stem group, or audio effect may be mapped to a specific input variable by metadata that is stored with the stem, stem group, or audio effect. A user may be able to use a software interface to map specific stem, stem group, or audio effect to desired input variable. For example, a user may map a stem group of percussions to an input variable from the accelerator. Further, the user may define the mapping by indicating the relationship between the accelerator input variable and the stem group of percussions. For instance, a user may define that pressing the accelerator causes the stem group of percussion to play at a faster speed and a louder volume. Further, the user may also define that a particular filter is applied to the stem group of percussions when the vehicle is below a specified speed, while another filter is applied when the vehicle 170 is above another specified speed. Each of these parameters may be stored with the stem group of percussions such that the vehicle is able to correctly map the stem group to the correct input variables. Further description of systems for associating stems, stem groups, or audio effects with input variables will be provided below.

Similar to the above mappings, the Sound Generation Engine 140 may also comprise default mappings if other mappings are not provided. For example, the input variables for the suspension of the vehicle 170 may be mapped to percussions, while input variables for the accelerator may be mapped to a guitar. One will appreciate that the listed mappings are provided only for the sake of example. Various additional or alternative mappings may also be used without departing from this disclosure. Additionally or alternatively, the Sound Generation Engine 140 may also utilize non-speaker features of the vehicle to create a fuller audio experience. For example, the Sound Generation Engine 140 may cause the driver's seat or steering wheel to vibrate based upon sensor data. Such a feature may allow for a more immersive audio experience. In at least one embodiment, the parameter configuration can be setup across all channels to give the vehicle an ultra flex, hyper dynamic audio/sensory intelligence.

Additionally, in at least one embodiment, one or more input variables may be dynamically scaled by the Sensor API 150. For example, an input variable relating to speed or acceleration may be dynamically scaled based upon a speed limit for the road where the vehicle 170 is traveling. For instance, an input variable from a vehicle sensor may comprise a vision system that reads speed limit signs or a location/map system (such as GPS) that provides a speed limit from a map or database based upon the vehicle's detected location. The Sensor API 150 may scale the input variables such that the full range of audio effects can be applied within the speed limit. For example, metadata associated with a particular stem may indicate a lower speed and a higher speed at which different audio effects are applied. In at least one embodiment, the Sensor API 150 scales the lower speed and higher speed so that they both fit within the speed limit of the road on which the vehicle is driving. Accordingly, the Sensor API 150 is configured to encourage safe driving by ensuring that audio effects are scaled to be applied within the speed limit.

### III. Dynamic Generation and Customization of Music

In at least one embodiment, a user's vehicle 170 is capable of acting as a soundscape composition system while the user drives from point A to point B. Such a system turns a vehicle 170 into an ecosystem for new creative experiences. Disclosed embodiment open doors for the creative community to create soundscapes for drivers to add new color compositions to the world of music and audio journeys. Users can then sell, license, or otherwise share their soundscape compositions through streaming services or other downloadable services.

For example, in at least one embodiment, the Sensor API 150 feeds data to the Sound Generation Engine 140, which in turn generates a custom, dynamic soundscape for the driver and passengers of the vehicle. In some embodiments, the Sound Generation Engine 140 includes an artificial intelligence algorithm that processes the data received from the Sensor API 150 as well as data specific to the driver. The artificial intelligence algorithm creates a soundscape that is being created in real-time and that is also personalized to the driver.

Additionally, in at least one embodiment, one or more modes may be associated with the playback of the soundscape. For example, a vehicle's audio system may comprise various modes, such as aggressive, relaxed, upbeat, etc. The Sound Generation Engine 140 may adjust the soundscape based upon the audio system mode. Additionally or alternatively, the Sound Generation Engine 140 may adjust the soundscape based upon a driving mode of the vehicle 170. For example, many vehicles have eco drive modes, sport drive modes, normal drive modes, and various other drive modes. Each drive mode may be comprised with unique scalings, limits, and/or AI responses. For instance, placing the car in sports mode may cause the Sound Generation Engine 140 to play faster audio effects and louder volumes, whereas the eco mode may lead to slow audio effects and lower volumes.

The following discussion relates to non-limiting examples of the Dynamic Sound Generation Software 130. These examples are provided only for the sake of explanation and clarity and should not be read to limit or otherwise define critical or important features of the invention.

The sound of a vehicle 170 traveling down a highway may generate a natural rhythm based upon road noise from seams in the roadway or based upon the driver traveling on a rumble strip on the edge of the roadway. In at least one embodiment, sensors within the suspension of the vehicle 170 may identify the rhythm and communicate them to the computer system 100 through the Sensor API 150. The Sound Generation Engine 140 may generate an acoustic fingerprint from the recorded rhythm. The acoustic fingerprint may be created using a spectrogram, or using any other method of acoustic fingerprinting used within the art.

The Sound Generation Engine 140 may then map the acoustic fingerprint to pre-stored acoustic fingerprints within the Music Library Storage 160. The Music Library Storage 160 may include a database of beats, rhythms, hooks, melodies, etc. that are associated with pre-stored acoustic fingerprints. Upon identifying a match or closest match to the generated acoustic fingerprint of the road noise, the Sound Generation Engine 140 may insert the identified match or closest matching music from the Music Library Storage 160 into the soundscape.

Additionally or alternatively, the Sound Generation Engine 140 may access from the Music Library Storage 160 a package of stem groups that are each mapped to a respective input variable. The input variable that relates to the suspension sensors may be used to manipulate the stem group that is associated with the suspension. For example, the Sound Generation Engine 140 may apply a filter, adjust a filter, adjust a speed, adjust a volume, or perform any number of other audio adjustments to the stem group. For instance, the Sound Generation Engine 140 may speed up the audio of the stem group until its rhythm matches the rhythm (or a factor of the rhythm) of the suspension vibrations.

Additionally, in at least one embodiment, while searching the Music Library Storage 160 for a matching acoustic fingerprint, the Sound Generation Engine 140 may limit the scope of the search based upon the profile of the driver. For example, the driver profile may indicate a preference for Country music. As such, the Sound Generation Engine 140 may limit the search within the Music Library Storage 160 to only stems, stem groups, beats, rhythms, hooks, melodies, etc. that fall within the Country music genre.

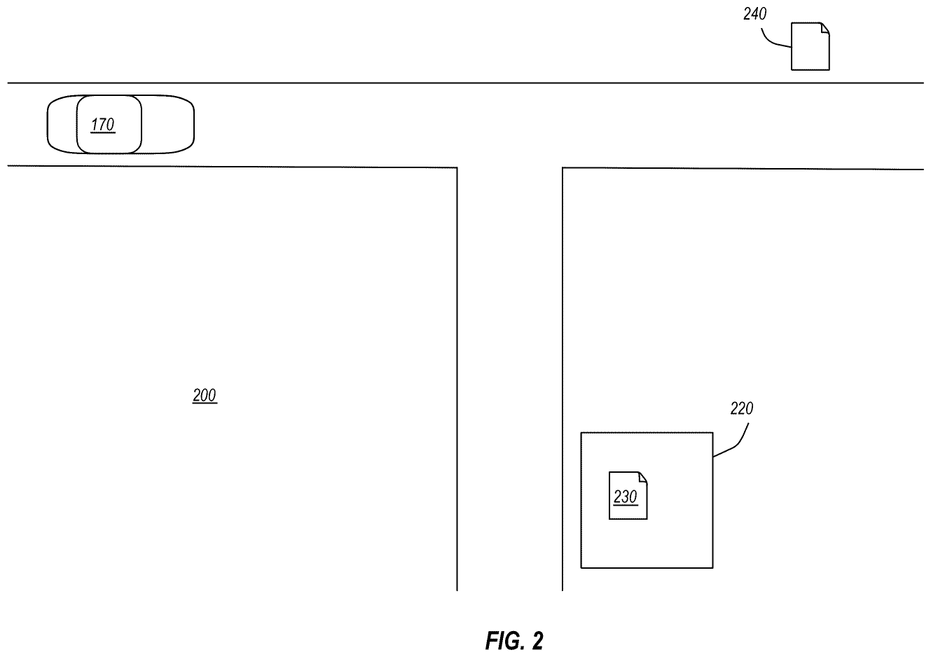

In an additional or alternative embodiment, the Sound Generation Engine 140 may utilize GPS and map data when generating a soundscape. For example, FIG. 2 illustrates a schematic diagram of a roadway 200 and a vehicle 170. The Sound Generation Engine 140 may use GPS data to identify the type of area through which the vehicle 170 is traveling. For example, if the vehicle with traveling down the Pacific Coast Highway, the Sound Generation Engine 140 may generate songs with a beach vibe. Additionally, the Sound Generation Engine 140 may rely upon stems, stem groups, beats, rhythms, hooks, melodies, etc. from within the Music Library Storage 160 that are based upon songs from bands such as the Beach Boys, Jack Johnson, Colbie Caillat, and other musicians with a notable “beach vibe.”

As another example of the Sound Generation Engine 140 utilizing input variables in the form of location data (e.g., GPS data), if the Sound Generation Engine 140 detects that the vehicle is entering New York City, the Sound Generation Engine 140 may generate a soundscape with a stronger urban music influence. For example, the Sound Generation Engine 140 may generate a soundscape that is based upon a sampling of recent music that was created by music groups based in New York City. Similarly, the Sound Generation Engine 140 may utilize GPS data to identify the hit songs in the local market or songs referencing or related to where the vehicle is traveling. As such, the Sound Generation Engine 140 may generate a soundscape that is based, at least in part, on the current list of hit songs within New York City, or songs famously referencing or related to New York City. For example, in FIG. 2, digital data packet 240 may represent location specific stems or audio files that the vehicle 170 can access as it enters the general geographic area that has been associated with digital data packet 240. One will appreciate that the visual representation of digital data packet 240 and digital data packet 230 is provided only for the sake of example. In practice, the digital data packet 240 may not necessarily be physically located at a geographic location. Instead, the digital data packet 240 may be hosted on a server and provided to the vehicle 170 when the vehicle arrives within a threshold distance of the digital data packet 240 location. Additionally or alternatively, in at least one embodiment, the digital data packet 240 may be hosted by a server positioned at the geographic location such that the stems or audio files are provided to vehicles through a local-area network when a vehicle 170 enters the range of the network.

In at least one embodiment, the Sound Generation Engine 140 only generates soundscapes that conform to the user profile. For example, a user may indicate a preference for Hip Hop music and Rock Music and may also indicate a dislike of jazz music. In response, the Sound Generation Engine 140 may only generate soundscapes that align with Hip Hop Music and Rock Music, while avoiding soundscapes that utilize elements of jazz music.

In an additional or alternative embodiment, the Sound Generation Engine 140 may also utilize location data to identify current weather conditions in the area of the vehicle 170. For example, the Sound Generation Engine 140 may use an online weather service to determine that it is currently snowing in the area where the vehicle is traveling. In response to identifying that it is snowing, the Sound Generation Engine 140 may create a soundscape that is informed by the weather. In this case, the soundscape may comprise warmer and softer tones and/or may comprise sound elements that are based upon music relating to winter (e.g., Christmas music). In contrast, if the Sound Generation Engine 140 determines from the weather outside is sunny, the Sound Generation Engine 140 may generate a soundscape that is upbeat and faster paced. One will appreciate that a number of different attributes can be associated with different weather patterns. As such, the examples provided above are merely for the sake of clarity and discussion. Any number of different soundscape characteristics can be generated based upon data received from a weather report.

The sound Generation Engine 140 may also receive map data relating to the travel plans on the driver. For example, the Sound Generation Engine 140 may receive an origin and destination for the vehicle. In response, the Sound Generation Engine 140 may generate a soundscape that takes into account the entire trip that the vehicle is planning. For example, the Sound Generation Engine 140 may account for the times of day, the expected weather, expected traffic patterns, and other trip related data when creating a soundscape. At the beginning of the trip the Sound Generation Engine 140 may generate an upbeat and energizing soundscape to motivate the driver on the journey. As the driver approaches expected traffic later in the drive, the Sound Generation Engine 140 may generate a calming soundscape to help the driver better navigate the traffic. If the journey is ending at a late hour, the Sound Generation Engine 140 may generate a loud and exciting soundscape to assist the driver in staying awake and attentive.

Additionally, in at least one embodiment, a voice assistant may also be incorporated into the soundscape. For example, if a driver is receiving driving directions from a voice assistant, the Sound Generation Engine 140 may manipulate the voice assistant such that the voice assistant speaks at a volume, cadence, beat, effect, etc. that matches the soundscape. For instance, the Sound Generation Engine 140 may cause the voice assistant to speak with an echo that matches the rhythm of the soundscape. As another example, the Sound Generation Engine 140 may cause the voice assistant to sing in a style that matches the soundscape.

In at least one embodiment, at least a portion of the soundscapes created by a driver are stored within the Music Library Storage. The Music Library Storage may be located locally in the vehicle, in the cloud, locally at particular locations, or in a combination of local and cloud storage. The driver may be able to access and listen to the soundscapes at a later date, share the soundscapes with others, sell or license the soundscape, or otherwise handle the soundscapes as the driver pleases. For example, a well-known music artist may create a particular soundscape based upon a drive from Los Angeles, California to Santa Barbara, California. Other drivers may be able to purchase, or otherwise listen to, that same soundscape.

For example, another driver may be planning on taking that same trip from Los Angeles, California to Santa Barbara, California. That driver may be interested in experiencing the same soundscape that was created by that music artist. As such, that user may purchase or license the soundscape that music artist created on that same journey. In at least one embodiment, the Sound Generation Engine 140 may adjust and revise the original soundscape in real-time based upon the location of the driver along the journey. For instance, the driver may leave at a different time than the composer of the original soundscape left. Due to differences in traffic, the driver's location may not be synced with the location of the soundtrack composer. As such, the Sound Generation Engine 140 may extend or shorten specific portions of the original soundscape to ensure that the driver's location is synced to the locations within the original soundscape. As such, as the driver travels over specific locations between Los Angeles, California to Santa Barbara, California the driver is experiencing the soundscape as it was created by the original composer.

In additional or alternative embodiments, music artists can also create custom audio layers or stems that the artists geolocates at specific locations on a map. The Music Library Storage 160 may store several custom audio layers from different artists, and at least a portion of the audio layers may be geolocated to specific locations. For example, an artist may create an audio layer and associate it with a particular location on Park Avenue in New York City. When a vehicle drives through the specific location, the Sound Generation Engine 140 may be able to access and add the audio layer to the current soundscape. In at least one embodiment, the driver is given options as to whether they would like to automatically incorporate audio layers from artists into their drive.

In some embodiments, the acquisition of audio layers from music artists can be gamified. For example, as drivers pass through the locations designated by the artists, the Sound Generation Engine 140 is able to be unlocked or download the audio layers. For example, if the vehicle 170 pass building 220, the vehicle 170 may gain access to digital data packet 230. Digital data packet 230 may comprise stems and/or audio files that the user can now utilize in creating a soundscape. In at least one embodiment, once a driver acquires an audio layer, the driver is able to use the audio layer at will in any location. As such, as a driver acquires more and more audio layers, the driver is able to create increasingly complex and interesting soundscapes by utilizing the layers.

In additional or alternative embodiments, advertising material may also be incorporated into the soundscape. For example, in some configurations, as a driver drives a vehicle down a roadway, the Sound Generation Engine 140 may identify nearby locations that have advertising material prepared for the system. For instance, before the vehicle passes a fast-food restaurant (e.g., building 220) an advertising audio layer (e.g., digital data packet 230) prepared by the fast-food restaurant company may be added to the soundscape. The fast-food restaurant company may prepare a series of audio layers that are distinct to different user genre preferences, such that different drivers may load different audio layers at that same spot based upon the drivers'respective profiles. Accordingly, as a driver passes particular points, the driver may be provided with custom advertising material that is layered into their custom soundscape.

In at least one embodiment, a driver is able to pay a subscription fee to avoid advertising. Additionally, a user may be able to select advertisements that interest them personally. Further, the Sound Generation Engine 140 may also “smartly” identify advertisements of interest. For example, the Sound Generation Engine 140 may place the fast-food advertisement around lunch time, but not play it at 3 PM. Similarly, the Sound Generation Engine 140 may play an advertisement for a gas station when the fuel sensor indicates that the fuel level is low but not play gas station advertisements when the fuel sensor indicates that fuel level is high.

Accordingly, there are various ways in which the Sound Generation Engine 140 is able to create a custom soundscape that is responsive to the driver, response to the location of the vehicle, responsive to loaded content (e.g., audio layers from music artists), responsive to the weather, and/or responsive to a variety of other inputs.

### IV. Example Method for AI Generated Sounds From Automotive Inputs

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

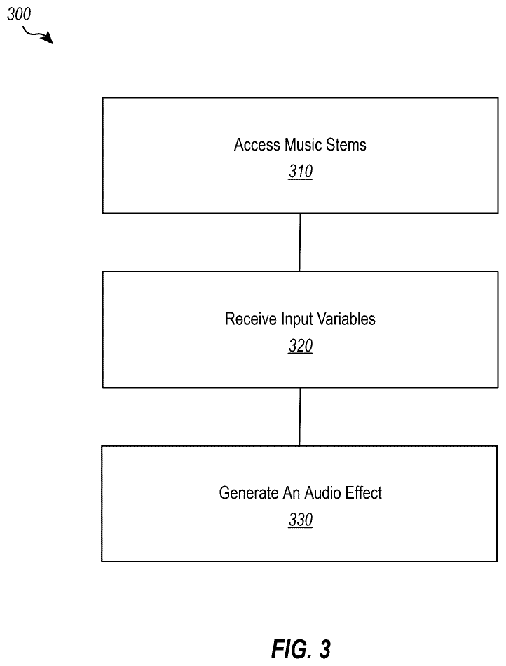

FIG. 3 illustrates a flow chart of a method 300 for generating AI generated sounds from automotive inputs. Method 300 includes an act 310 of accessing music stems. Act 310 comprises accessing a package of one or more music stems. For example, the computer system 100 may access music stems that are stored within the music library storage 160.

Additionally, method 300 includes an act 320 of receiving input variables. Act 320 comprises receiving an input variable from a vehicle sensor. The vehicle sensor measures an aspect of the driving parameters of a vehicle. For example, the Sensor API 150 may receive data from a sensor connected to the accelerator pedal.

Method 300 may further include an act 330 of generating a sound. Act 330 comprises in response to the input variable, generating a particular sound that is mapped to the input variable. For example, the Sound Generation Engine 140 may create a custom soundscape within the vehicle based on the drivers pressing and releasing of the accelerator pedal.

In at least one embodiment, the Sound Generation Engine 140 may also be configured to create an external soundscape for the vehicle 170. The external soundscape may match the internal soundscape or may comprise different sounds. For example, the Sound Generation Engine 140 may generate an external soundscape as a safety feature for electric vehicles. In many cases, electric vehicles are so quiet during normal operation that a pedestrian may not hear the vehicle backing up or approaching from behind. As such, in at least one embodiment, the Sound Generation Engine 140 can utilize input variables to create an external soundscape to provide warning to others about the vehicles approach. For instance, in at least one embodiment, placing the vehicle 170 in reverse causes an external speaker on the car to play the internal soundscape. Additionally or alternatively, a different soundscape may be played on the external speakers. The external soundscape may utilize stems or stem groups to create a custom soundscape based upon the input variables from the vehicle 170.

### V. System for Creating Soundscape Packages

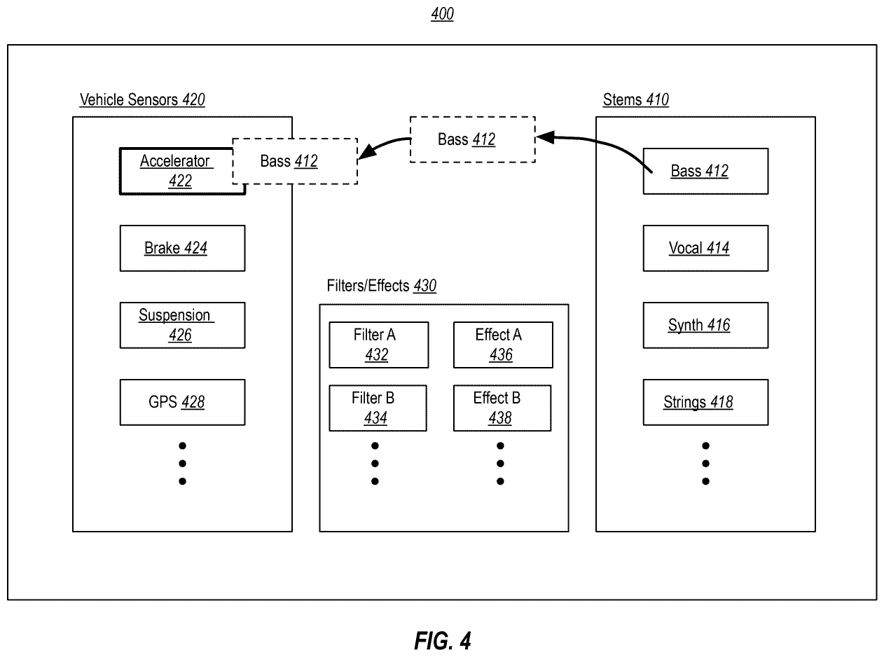

In at least one embodiment, a computer system may provide a user with an interface for creating soundscape packages. FIG. 4 illustrates a user interface 400 for generating AI generated sounds from automotive inputs. As used herein, soundscape packages comprise audio components, such as stems, that have been associated with input variables received from vehicle sensors. For example, an interface may display visual representations of audio stems 412, 414, 416, 418 within a selection of stem groups 410. The stem groups 410 may be provided to the computer system by a music artist who has uploaded the stem groups into the computer system. The user may then be able to associate one or more of the stems 412, 414, 416, 418 with visual representations of specific input variables 420 (e.g., accelerator 422, brake 424 suspension 426, GPS 428, etc.) and/or visual representations of specific filters and/or audio effects 430, 432, 434, 436, 438. For instance, the user may associate the bass stems 412 with the acceleration 422 of the vehicle 170. Such an association may be accomplished by dragging the bass stems 412 onto a visual indication of the accelerator 422.

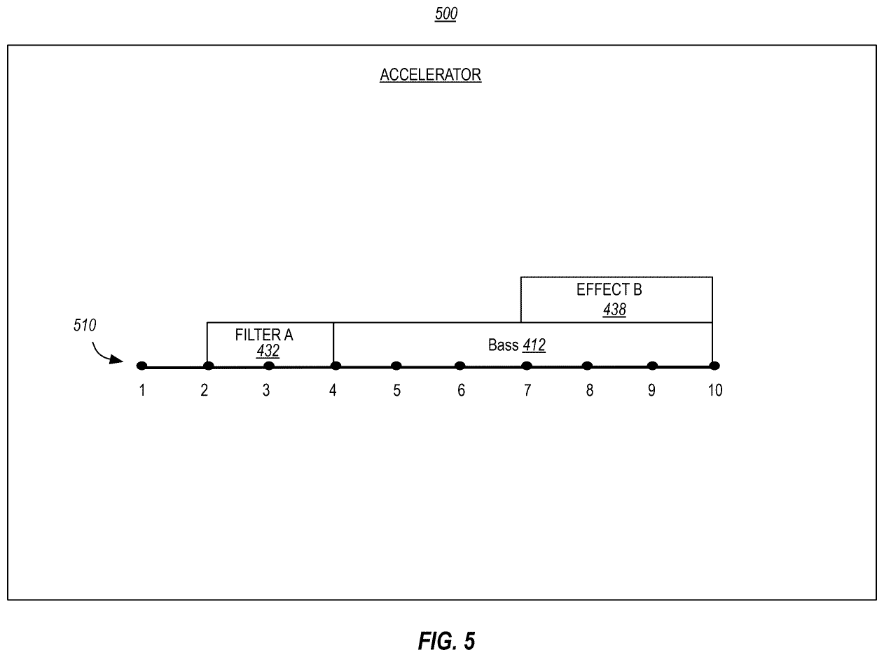

FIG. 5 illustrates another user interface 500 for generating AI generated sounds from automotive inputs. Once the user has associated the bass stems 412 with the acceleration 422, user interface 500 may allow the user to further customize the interactions between the specific input variables 420 and the stem groups 410. For example, in the user interface 500, a scaled line 510 for the accelerator is depicted. As described further herein, the scaled line 510 may be utilized to allow the computer system 100 to scale the soundscape to the speed limit of a given road and/or to allow the computer system 100 to scale the soundscape to a particular model of car.

In the user interface 500, the user has associated Filter A 432 with the accelerator input variable from a scale of 2 to 4. Once the accelerator 422 reaches a level 4 on the scaled line 510, the Bass stems 412 are associated with the accelerator 422. Further, once the accelerator 422 reaches a level 4 on the scaled line 510, the Bass stems 412 become associated with the input variables from the accelerator. Further, once the accelerator 422 reaches a level 7 on the scaled line 510, the Effect B 438 becomes associated with the Bass stems 412 and the accelerator 422. Further, once the accelerator 422 reaches a level 4 on the scaled line 510. As such, when initially accelerating, a user may first hear a Filter A 432 applied to the soundscape. The Filter A 432 would transition to the Bass stems 412 at a certain point in the acceleration. Eventually, the Effect B 438 would be applied to the Bass stems 412. One will appreciate that the user may add further audio effects such as particular filters that should be applied at different times based upon one or more input variables. For example, the user may indicate that a distortion filter should be applied to the percussion stems during an initial period of acceleration for the vehicle.

Once the user has completed their desired association of the stem groups with input variables and audio effects, the computer system may create a soundscape package that is formatted to be read by a computer system in the vehicle. In at least one embodiment, the soundscape package comprise metadata associated with the package and/or stem groups within the soundscape package. For instance, each individual stem group may be saved with metadata associating the stem group with one or more input variables from one or more vehicle sensors and one or more audio effects.

In at least one embodiment, the computer system may place limits on various input variables. For example, the computer system may place a ceiling at 100 MPH for any speed input variables. Additionally or alternatively, the computer system may place a dynamic ceiling on speed input variables based upon the real-time speed limit for the vehicle. In at least one embodiment, when associating a stem group with an input variable, such as speed, the user specifies the relationship on a scale instead of on actual numerical values. For example, the user may indicate that at level 8 (on an example scale of 1-10) a particular filter should be added. The scale information may be encoded into the metadata associated with the stem group. When in use, the vehicle may identify the current speed limit and normalize the scale to the speed limit such that at 80% of the speed limit, the particular filter is added. One will appreciate that this example of a 1-10 scale, a speed input variable, and a filter are merely exemplary and that this process could be applied to any number of different input variables.

In at least one embodiment, the computer system may place limits on various audio effects. For example, the computer system may place a limit on the volume level allowed for a particular stem group and/or soundscape package. For example, the user may indicate that a level 8 (on an example scale of 1-10) of volume should be used. The scale information may be encoded into the metadata associated with the stem group. When in use, the vehicle may identify the current volume level for the audio system and scale the audio of the stem group accordingly. One will appreciate that this example of a 1-10 scale and a volume level are merely exemplary and that this process could be applied to any number of different audio effects.

In additional or alternative embodiments, the computer system may also link various input variables together. For example, in response to a first input variable, such as the acceleration of the vehicle, the Sound Generation Engine 140 may apply a particular audio effect, such as increase in volume, to the one or more music stems. The Sensor API 150 may then determine that the first input variable crosses a threshold. For example, the Sensor API 150 may determine that the driver has release the accelerator by more than a threshold amount. Based upon the first input variable crossing the threshold, the Sound Generation Engine 140 may apply the particular audio effect (e.g., volume) to the one or more music stems in response to a second input variable.

For example, it may create an undesirable soundscape if a particular audio effect is immediately cut from the soundscape based upon the driver stepping off the accelerator pedal. In order to create a more seamless soundscape experience, when the Sensor API 150 detects that the accelerator has been released to a threshold amount, the Sensor API 150 may switch to associating the vehicle speed with the particular music stems and/or audio effect. Accordingly, when the user releases the accelerator pedal, the stems and audio effects associated with the acceleration of the vehicle may seamlessly switch to an association with the vehicle speed. Such a switch should provide a more continuous and subtle decline in the audio effect and music stems. One will appreciate that the example provided is not limiting. Any number of different audio effects, input variables, and stems may be associated with thresholds that cause the Sensor API 150 and/or Sound Generation Engine 140 to switch associations between input variables, audio effects, and stems in order to create a better soundscape experience.

Additionally, in at least one embodiment, it may be desirable to adjust the soundscape based upon characteristics of the vehicle in which the soundscape is being played and created. For example, different vehicles comprise different audio systems, different haptic systems, and different performance characteristics. A sports car with a high-end stereo system will provide a very different soundscape experience than a large SUV with a lower end stereo system.

In at least one embodiment, a soundscape package may be customized to operate with a particular type and configuration of a car. For example, each type and configuration of vehicle may download slightly different soundscape packages that have metadata that has been optimized to work with the particular vehicle type and configuration. Additionally or alternatively, the Sound Generation Engine 140 may be configured to apply a transfer function and/or predetermined scaling to a soundscape package in order to optimize the soundscape experience to the vehicle. For example, each type and configuration vehicle may be acoustically characterized such that each audio effect is associated with a scaling or transfer function that optimizes the particular audio effect for the given vehicle. Further, the performance of each type and configuration of vehicle may be characterized such that each input variable from a vehicle sensor is associated with a scaling or transfer function that optimizes the input variable for the given vehicle. As used herein, a “scaling” may comprise either a linear scaling or a non-linear scaling. In at least one embodiment, a “scaling” may comprise an equation or step-function.

For example, the scaling or transfer function may cause input variables related to acceleration to apply a larger impact from the sports car than input variables related to acceleration from the SUV. Similarly, the scaling or transfer function may apply smaller impacts on bass effects within the better audio system of the sports can than bass effects on the lesser audio system in the SUV. By making these described optimizations, the acceleration of the two different types of vehicles may be better mapped to the soundscape and the bass effects of the two vehicles may be better discernable through the different classes of stereos.

In at least one embodiment, a music creator may also be able to associate specific stems from a song with a particular geolocation. For example, a musician may desire to hold a secret concert. The directions for getting to the concert may be hid within a soundscape that the musician creates. For example, the musician may associate one or more stem groups within the location of the concert such that as a driver drives close to the concert the one or more stem groups play louder and/or faster. Accordingly, a fan of the musician can find the secret concert by following the soundscape created within the fan's vehicle as the get closer and closer to the concert location.

In an additional or alternative embodiment, a music creator can utilize geolocation information for a wide variety of different purposes. For example, the music creator can create a “treasure hunt” for listeners. The metadata associated with stems can guide a user to a particular physical location by volume, beat, or some other audio metric. Once the user arrives at the particular location, the user may be provided with a particular physical item, such as a coupon, a meal, a product, or any other physical item. Similarly, a music creator may create metadata associated with a particular physical location where a new album or soundtrack is unlocked for the user's listening. Similar geolocation features may also be used for a guided tour. For example, the metadata may direct a user to multiple different locations along the pathway of a guided tour. At particular locations, the soundscape may change to incorporate verbal communications describing the locations or otherwise accompanying the guided tour. Additionally, in at least one embodiment, metadata associated with stems can be time limited such that the particular geolocation is only active during a specified time.

In at least one embodiment, the computer system for creating soundscape packages may also provide functionality to add digital rights management features to the resulting soundscape package. For example, each soundscape package may be signed and/or encrypted within a unique token. The token for decrypting the encryption may only be provided to approved users such that only approved users can decrypt the soundscape package within their vehicle. Further, the digital rights management features may prevent the soundscape package from being played by a non-approved system. For example, only systems that have been specifically approved to play soundscape packages may be provided with the necessary tools to satisfy the digital rights management features.

Additionally, in at least one embodiment, when a driver creates their own composition using the soundscape package, the same digital rights management features may apply to any recordings of the driver's composition as well. Such a feature may restrict the driver's ability to share licensed soundscape package content with non-approved individuals or systems. Accordingly, soundscapes and associated licensing rights may be managed within the system to prevent unauthorized sharing and/or unauthorized playback of artist content.

### VI. Identification of Stems and Sections Within Digital Audio Files

Disclosed embodiment include a computer system and a computer-implemented method for dynamic chunking of sounds for automotive inputs at a vehicle. The system may comprise one or more processors and one or more computer-readable media having stored thereon executable instructions that when executed by the one or more processors configure the computer system to dynamic chunk digital audio files for sounds from automotive inputs within a vehicle. For example, as depicted in FIG. 1, the computer system 100 can receive a digital audio file 102 for a particular song. The digital audio file 102 may be stored within a music library storage 160. As used herein, a digital auto file 102 may comprise a variety of different file types, including but not limited to WAV, AIFF, AUI, MP3, AAC, FLAC, OGG, and WMA.

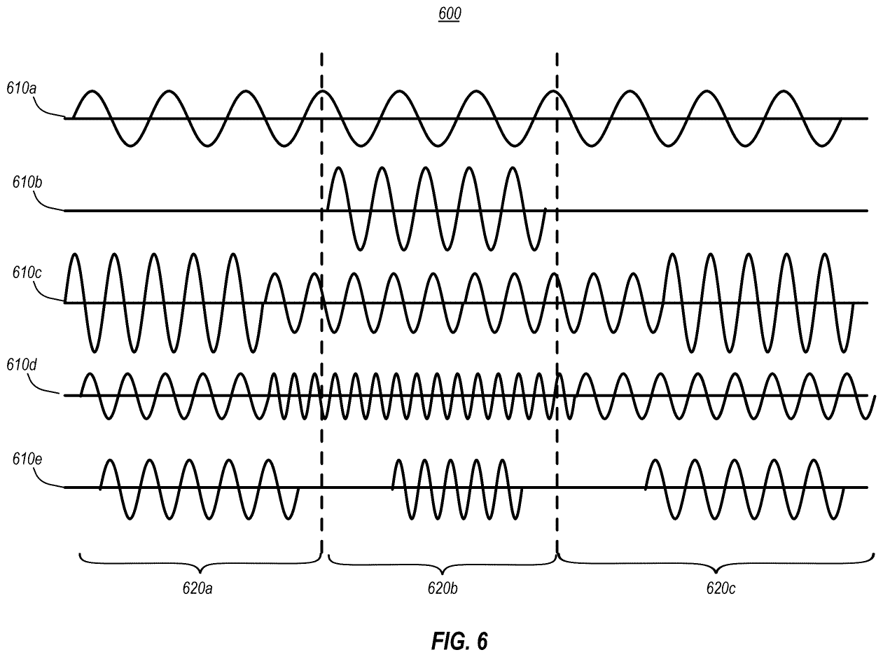

Upon receiving the digital audio file 102, the Dynamic Sound Generation Software 130 processes the digital audio file 102 into a plurality of stems and sections. For example, FIG. 6 illustrates example stems 610(a-e) divided into sections 620(a-c). In at least one embodiment, to generate the stems 610(a-e) and the sections 620(a-c), the sound generation engine 140 may generate one or more waveforms 600 from the digital audio file 102 and analyze the one or more. waveforms to identify sections 620(a-c) based on changes in components of the one or more waveforms 600.

One of skill in the art will appreciate that the sine waves depicted in FIG. 6 are greatly simplified and shortened for the sake of clarity and explanation. Each stem 610(a-e) represents a separate component or element of a song. Stems are individual audio files that break down a complete track into separate elements, such as vocals, instruments, bass, and drums, allowing for greater control and customization in music production. These stems can be mixed and manipulated independently, making them useful for remixing, mastering, and creating dynamic soundscapes. Each section 620(a-c) comprises a continuous portion of the song.

In at least one embodiment, the process of identifying sections 620(a-c) in a digital audio file 102 begins in the sound generation engine 140 with the creation of stems 610(a-e) from the digital audio file 102 (e.g., a stereo file). This involves splitting the audio into its individual components, such as different instruments or vocal tracks. In at least one embodiment, the sound generation engine 140 can either receive pre-existing stems 610(a-e) or generate them from a stereo file using a stem-splitting algorithm. Example stem-splitting algorithms include open-source algorithms such as Spleeter and Demucs.

Either before or after the stems 610(a-e) are obtained, the sound generation engine 140 analyzes the waveform to identify where new instruments or components are introduced and where others diminish. The sound generation engine 140 is able to identify notable shifts in the digital audio file. The sound generation engine 140 looks at both the tempo information, mapping it to a grid, and the frequency information to determine significant changes in the digital audio file. This dual approach ensures that the system can accurately identify transitions and changes in the digital audio file's structure.

The identified sections 620(a-c) are typically 4, 8, or 16 bars long, depending on the characteristics of the song. These sections 620(a-c) are then used to create chunks that can be downloaded and played back seamlessly. This chunking process allows for a more efficient and responsive playback experience, as it prevents the need to download the entire track at once. Instead, the system can dynamically load and play back sections based on the user's interactions and the song's structure, creating a fluid and adaptive listening experience.

For example, in the waveforms 600 of FIG. 6, a waveform of each stem 610(a-e) is depicted. The sound generation engine 140 can analyze the stems 610(a-e) and identify changes in the waveforms. For example, the sound generation engine 140 identified three sections 620a, 620b, 620c in this example. These sections are visibly distinguishable by the introduction of content in stem 610b, the change of content in stem 610d, and the change in content in stem 610e. The sections 620(a-c) may represent different parts of a song such as the chorus, introduction, bridge, hook, interlude, etc. Alternatively, the sections 610(a-c) may just represent sections where the characteristics of the song change.

In at least one embodiment, the sections 620(a-c) can be identified using a machine learning algorithm that has been trained to identify sections 620(a-c) within a digital audio file. For example, the machine learning algorithm can be trained based upon a labelled dataset of digital audio files that have been manually sectioned by an expert human user. In various embodiments, a variety of different machine learning algorithms may be used. For example, machine learning algorithms for processing audio include Artificial Intelligence Algorithms, Neural Networks, Principal Component Analysis (PCA), Particle Swarm Optimization (PSO), Convolutional Neural Networks (CNNs), Mel-Frequency Cepstral Coefficients (MFCCs), Gammatone-Frequency Cepstral Coefficients (GFCCs), Linear-Prediction Cepstral Coefficients (LFCCs), and Deep Neural Networks (DNNs).

Once the sections 620(a-c) are identified, the sound generation engine 140 numbers the sections 620(a-c) in a priority sequence. When numbering the sections 620(a-c), the sound generation engine 140 will generally load the intro section 620a first and designate it as Section 1. Subsequent sections 620b, 620c are then numbered in a sequence that reflects their order in the song. The sound generation engine 140 can then use an energy score to help determine the priority of each section, with higher energy sections typically being prioritized for playback during periods of high activity, such as acceleration.

In at least one embodiment, the sound generation engine 140 calculates an energy score by analyzing the waveform of the digital audio file 102. The sound generation engine 140 looks at the amount of frequency information being passed through and the syncopation tied to the tempo. Peaks in the waveform are identified to determine high tempo and high energy sections. In at least one embodiment, the sound generation engine 140 can generate an energy score for an entire digital audio file, for each section 620(a-c), and for each stem 610(a-e). In at least one embodiment, an integral of a Fourier transform of the frequency information can be used to generate a desired energy score. The sound generation engine 140 can normalize the energy score by assigning an energy score out of 100 to each section 620(a-c) or stem 610(a-e). This score helps in prioritizing sections for playback during periods of high activity.

The sound generation engine 140 can associate the stems 610(a-e) from the sections 620(a-c) to input variables from one or more vehicle sensors received through the Sensor API 150. For example, the acceleration sensor may be associated with a bass stem (e.g., stem 610b). Additionally, the left and right gyroscope sensors may associate a synth stem (e.g., 610c), which are then introduced when the car is turning left or right. This association is part of the system's logic to create a dynamic and responsive audio experience.

The sound generation engine 140 can then generate a digital data packet (e.g., 230, 240) that includes one or more stems 610(a-e), one or more sections 620(a-c), and associations to input variables from one or more vehicle sensors. As will be explained more fully below, the digital data packet may comprise a single file that includes the entirety of a song or the digital data packet may comprise “chunks” of a song that are sent out in small pieces in order to adhere to memory and bandwidth constraints. As such, the digital data packet may not include all of the sections 620(a-c) and stems 610(a-e) from the digital audio file. For example, sending an entire song to a vehicle 170 may cause the processing unit with the vehicle to unduly delay or perform slower than acceptable. As such, in some embodiments, the digital data packet comprises a chunk of a song, where the chunk is small enough to be cached at the vehicle 170 within the processing unit. Accordingly, in some embodiments, it may be desirable to deliver the one or more stems 610(a-e) and one or more sections 620(a-c) as dynamic chunks.

Additionally, the digital data packet may comprise one or more sections with particular priorities. For example, the particular priorities included within the digital data packet may be based upon input variables received from the vehicle sensors. If the vehicle is speeding up or driving more aggressively, the digital data packet may contain music sections that have higher energy level scores. In contrast, if the vehicle is slowing down, the digital data packet may contain music sections that have lower energy level scores.

### VII. Dynamic Chunking for Sounds From Automotive Inputs

In at least one embodiment, processing the digital audio files in chunks enhances the user experience by making the playback of songs more dynamic and responsive to real-time inputs from various sensors in a car. By breaking down a song into smaller, manageable sections or “chunks,” the system can quickly and seamlessly adapt the music to changes in driving conditions, such as acceleration, braking, and turning. This approach prevents the need to download the entire song at once, reducing wait times and ensuring a smooth and instantaneous playback experience.

At least one benefit of this chunking method is that it allows for a more interactive and immersive audio experience. For instance, specific stems 610(a-e) or sections 620(a-c) of a song can be triggered by particular driving actions, such as introducing a horn section when the car turns left or right. This not only makes the music feel more integrated with the driving experience but also provides a unique and personalized soundtrack that evolves with the journey. Additionally, the system's ability to identify and prioritize high-energy sections of the song ensures that the music matches the intensity of the driving conditions, enhancing the overall enjoyment and engagement of the user

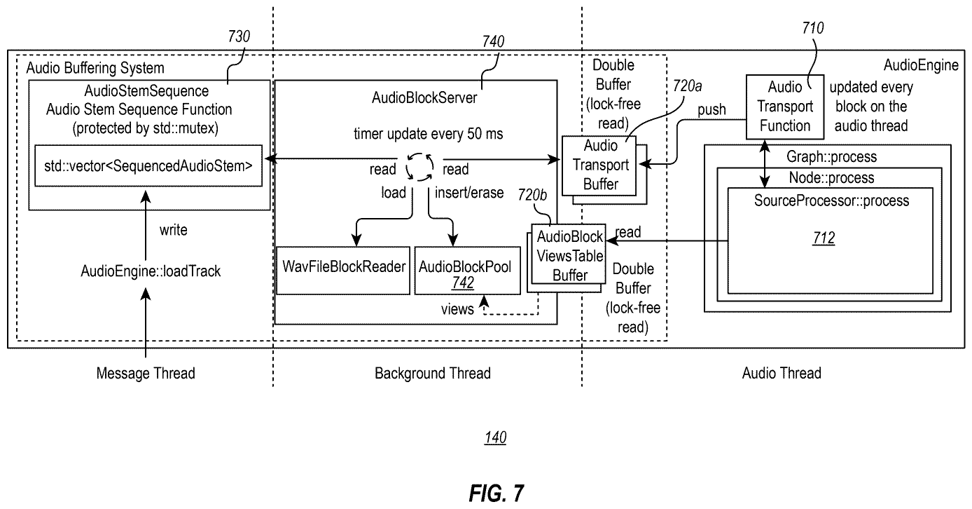

FIG. 7 depicts a schematic of an example sound generation engine 140 for managing the chunking of a digital audio file 102. In order to manage the chunking of the music, the sound generation engine 140 may comprise various different components, including an audio transport function 710, a source processor 712, and an audio buffering system 720a, 720b. FIG. 7 depicts two distinct buffer 720a, 720b, but one of skill in the art will appreciate that that a single buffer or multiple buffers can be used as required to meet hardware and software considerations. These components work in tandem to achieve real-time audio rendering and synchronization with the vehicle's driving actions.

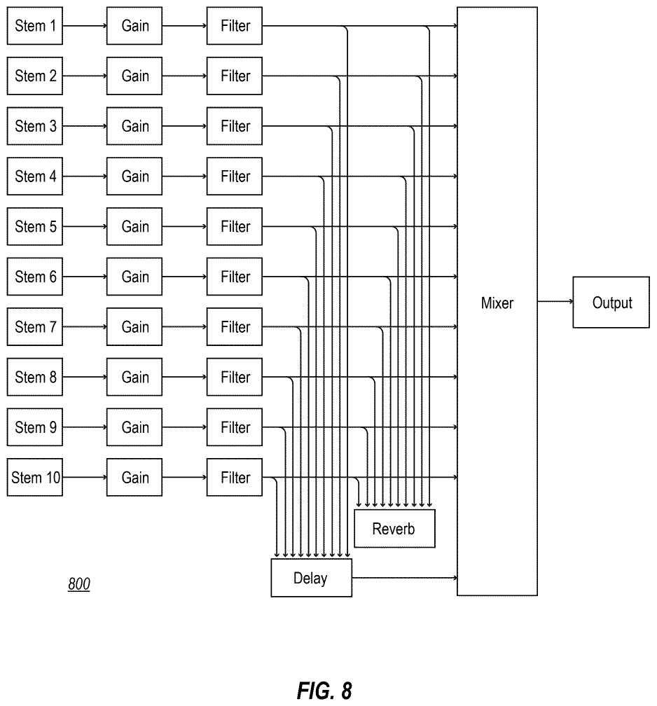

The sound generation engine 140 can serve as the highest-level class responsible for controlling and synchronizing the audio graph 800 (shown in FIG. 8), audio transport function 710, and audio buffering system 720a, 720b. The sound generation engine 140 ensures that all audio components work together seamlessly to provide a cohesive audio experience. In at least one embodiment, the audio transport function 710 maintains the current playback position, loop start and end positions, looping state, and playback state (playing, stopping, stopped, paused). For example, the audio transport function 710 may manage a data structure that ensures that the audio playback is accurately synchronized with the vehicle's driving actions. The audio transport function 710 is responsible for advancing the playback position and loop state, ensuring that the audio data is loaded in advance of rendering.

The source processor 712 may be embedded within the audio graph 800 and is responsible for rendering the loaded audio data. The source processor 712 retrieves audio data from the audio buffering system 720b and writes the correct data to its output, which is then processed by other processors in the audio graph 800. The source processor 712 is configured to read audio blocks from the audio transport buffer 720a, which is loaded from an audio block server 740. The source processor 712 then renders any audio blocks that overlap with the current processing block.

The audio buffering system 720a, 720b is configured to load only short sections of audio data from the storage (e.g., music library storage 160) just in time for play back. This audio buffering system 720a, 720b may utilize at least three components: the audio stem sequence function 730, audio transport function 710, and audio block server 740. The audio stem sequence function 730 maintains a record of what audio files are being used, where each audio file is placed on the timeline, and what mixer channel with the audio graph 800 each audio file should be playing through. The audio transport function 710 tracks the current playback position and loop state, ensuring that the audio data is loaded in advance of rendering. The audio block server 740 operates on a background timer thread, loading the required audio data from storage and presenting views of them to the source processor 712 in the audio block view table buffer 720b. The audio block view table buffer 720b may comprise a double buffer with lock-free read behavior.

In at least one embodiment, the audio stem sequence function 730 serves as a very thin mutex-protected wrapper around a std::vector<SequencedAudioStem>. One of skill will appreciate that std::vector is a dynamic array provided by the Standard Template Library (STL) in C++ programming. It allows for the storage of elements in a contiguous memory location and provides functionalities to dynamically resize the array as needed. The “SequencedAudioStem” is a custom data type that represents an audio stem, which is a reference to an audio file placed at a specific location on the timeline. The audio stem sequence function 730 serving as a thin mutex-protected wrapper around a std::vector<SequencedAudioStem> means that the audio stem sequence function 730 manages a collection of SequencedAudioStem objects, ensuring thread safety when updating the group of stems 610(a-e). The audio block server 740 can update audio block view table buffer 720b whenever necessary, and the rest of the sound generation engine 140 will react accordingly.

In at least one embodiment, the audio transport function 710 comprises at least a single instance of an audio transport data structure (i.e., “AudioTransport struct”), which tracks the current playback position and loop state. The audio transport function 710 can load the audio transport data structure into the audio transport buffer 720a for view and/or copying by the audio block server 740. Additionally, the audio block server 740 can operate on a background timer thread that runs an iteration every 50 ms. Based on the latest data from the std::vector<SequencedAudioStem> and audio transport function 710, the audio block server 740 can load the required audio data from storage into short audio “blocks” and present views of them to the source processor 712 through the audio block view table buffer 720b.

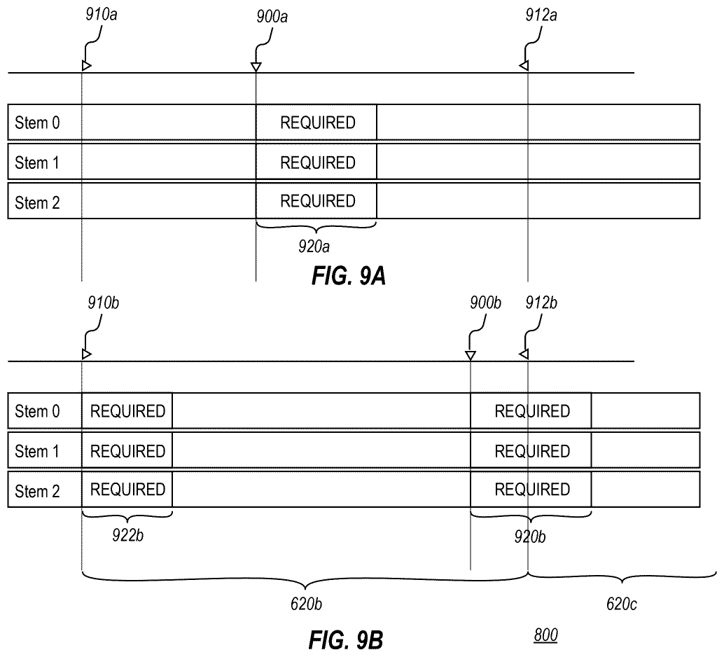

FIG. 9A and FIG. 9B illustrate schematics of different update processes for chunking a digital audio file. The update iteration within the audio buffering system 720a, 720b is specifically managed by the audio block server 740. This process ensures that the necessary audio data is loaded just in time for playback, thereby maintaining a seamless and uninterrupted audio experience. The update iteration may involve at least three steps. The first step in the update iteration may be to remove any “required” region from the audio block pool 742 that is no longer needed. The audio block pool 742 feeds the audio blocks in the audio block view table buffer 720b. Removing these blocks ensures that the sound generation engine 140 does not retain audio data that is no longer relevant, thereby optimizing memory usage.

The next step is to load audio data that is in a “required” regions but not yet in the audio block pool 742. This involves reading the necessary audio blocks from storage and preparing them for play back. As used herein, unless specified otherwise, “blocks” and “chunks” can be used interchangeably. FIGS. 9A and 9B depicts examples of identifying required regions. For example, in FIG. 9A, the play head 900a is depicted as being about midway between a loop start point 910a and a loop end point 912a. Accordingly, the required audio blocks 920a comprise the upcoming audio blocks for each stem within the currently playing section. In at least one embodiment, the portion of audio between the loop start point 910a and a loop end point 912a comprises a single section (e.g., 620c) of music.

In contrast to FIG. 9A, FIG. 9B depicts the play head 900b a being nearly at the loop end point 912b. In this case, the required blocks 920b, 922b comprise blocks from at least two different locations within the music. One set of required blocks 920b comprise blocks that transition from the current section 620b of music to the next section 620c of music. Additionally, the required blocks 922b also include blocks from the beginning of the current section 620b of music. By accessing both sets of required blocks 920b, 922b, the sound generation engine 140 is able to account for input variables from the vehicle sensors indicating that the loop should continue (in which case required blocks 922b would be used) or for the input variable to indicate that the next loop should start (in which case required blocks 920a would be used).

The third step for the audio block server 740 to update the audio block view table buffer 720b is to build the set of audio block views for each mixer channel (shown in FIG. 8) and write them into the audio block view table buffer 720b. These views are then ready to be picked up by the source processor 712, ensuring that the correct audio data is available for real-time processing.

The update iteration is configured to handle dynamic playback and looping states, which are determined by the source processor 712. The audio block server 740 can react to changes in these states, including last-minute activation or deactivation of looping. By knowing the playback position and the loop start and end points, the sound generation engine 140 can load audio data ahead of the current playback position and at the beginning of the loop if approaching the end of the loop.

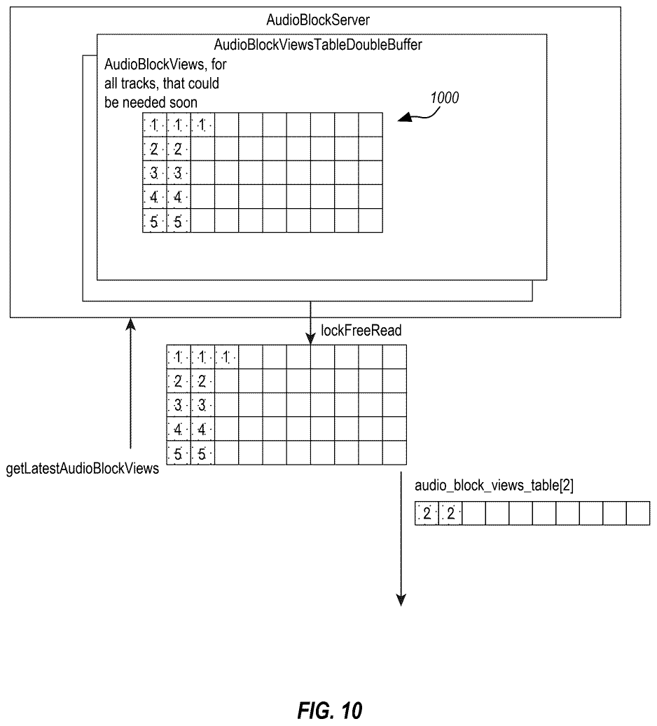

FIG. 10 illustrates a schematic of an example of an audio block view table buffer 720b. Each row in the array 1000 is associated with music block and each column is associated with a particular mixer channel (e.g., stem 610(a-e)). The source processor 712 can independently address any given row or column within the audio block view table buffer 720b. Accordingly, each block, or chunk, of music is provided on a per mixer channel basis to the source processor for communication to the audio graph 800.

In at least one embodiment, the output of the audio block view table buffer 720b comprises a digital data packet as described above. The digital data packet comprises at least portions of one or more stems and at least portions of one or more sections. In at least one embodiment, the digital data packet may also comprise associations of particular input variables from vehicle sensors with particular stems and/or sections within the digital data packet. The audio block server 740 can create an array of potential audio chunks for play back at the vehicle 170. The array 1000 comprises a first dimension (e.g., columns) that is defined by mixer channels and a second dimension that is defined by different audio tracks (e.g., rows) that are created from the one or more sections and the one or more stems.

In at least one embodiment, when in use the sound generation engine 140 plays a first stem from a first section of the particular song at the same time as a second stem from a second section of the particular song. This may occur when the second stem is associated with a particular vehicle sensor that is not associated with any stems within the first section of the particular song. For instance, the sound generation engine 140 may associate a drum stem (e.g., 610b) with the accelerator sensor. However, one or more sections (e.g., 620a and 620c) may not have any information within stem 610b. As such, in those sections 620a and 620c, if the audio graph 800 were to play the actual stem 610b from those sections 620a and 620c, no music would play within the vehicle 170. As such, in some cases, the sound generation engine 140 will cause that an audio block taken from stem 610b in section 620b play at the same time as an audio block from sections 620a or 620c.

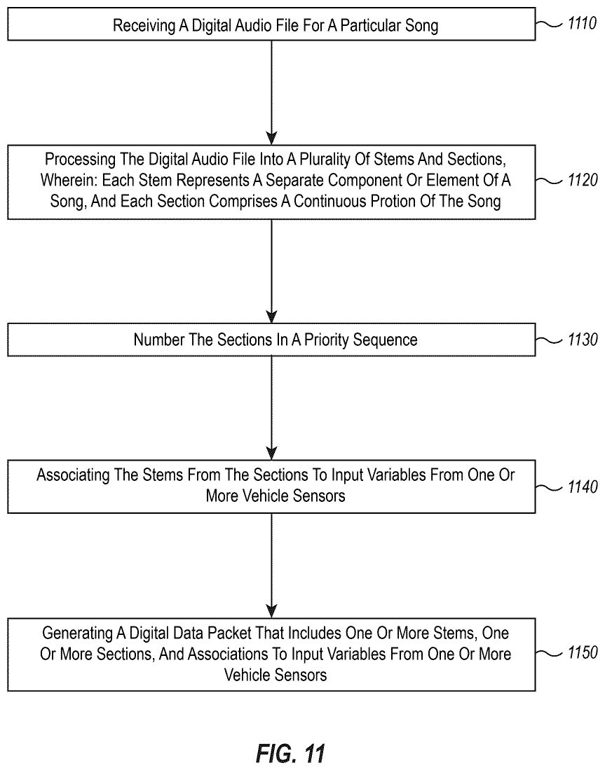

FIG. 11 is a flowchart of an example method for dynamic chunking for sounds from automotive inputs at a vehicle. At step 1110, a computer system receives a digital audio file for a particular song. At step, 1120, the computer system processes the digital audio file into a plurality of stems and sections, wherein: each stem represents a separate component or element of a song, and each section comprises a continuous portion of the song. At step 1130, the computer system numbers the sections in a priority sequence. At step 1140, the computer system associates the stems from the sections to input variables from one or more vehicle sensors. At step 1150, the computer system generates a digital data packet that includes one or more stems, one or more sections, and associations to input variables from one or more vehicle sensors.

### VIII. Aspects of AI Generated Sounds From Automotive Inputs

Clause 1. A computer system for dynamic chunking for sounds from automotive inputs at a vehicle, comprising: one or more processors; and one or more computer-readable media having stored thereon executable instructions that when executed by the one or more processors configure the computer system to: receive a digital audio file for a particular song; process the digital audio file into a plurality of stems and sections, wherein: each stem represents a separate component or element of a song, and each section comprises a continuous portion of the song; number the sections in a priority sequence; associate the stems from the sections to input variables from one or more vehicle sensors; and generate a digital data packet that includes one or more stems, one or more sections, and associations to input variables from one or more vehicle sensors.
Clause 2. The computer system as recited in clause 1, wherein processing the digital audio file into a plurality of stems and sections includes instructions that are executable to configure the computer system to: generate a waveform from the digital audio file; and analyze the waveform to identify sections based on changes in components of the waveform.
Clause 3. The computer system as recited in clause 1, wherein the executable instructions include instructions that are executable to configure the computer system to: assign an energy score to each section and each stem based on frequency information within each section and each stem.
Clause 4. The computer system as recited in clause 3, wherein: numbering the sections in the priority sequence is based on the energy score.
Clause 5. The computer system as recited in clause 1, wherein the executable instructions include instructions that are executable to configure the computer system to: play a first stem from a first section of the particular song at the same time as a second stem from a second section of the particular song.
Clause 6. The computer system as recited in clause 5, wherein playing the first stem from the first section of the particular song at the same time as the second stem from the second section of the particular song is based upon the second stem being associated with a particular vehicle sensor that is not associated with any stems within the first section of the particular song.
Clause 7. The computer system as recited in clause 1, wherein the digital data packet does not include all of the sections and stems from the digital audio file.
Clause 8. The computer system as recited in clause 7, wherein the digital data packet is cached at the vehicle.
Clause 9. The computer system as recited in clause 7, wherein the digital data packet comprises one or more sections with particular priorities.
Clause 10. The computer system as recited in clause 1, wherein generating the digital data packet that includes one or more stems, one or more sections, and associations to input variables from one or more vehicle sensors includes instructions that are executable to configure the computer system to: create an array of potential audio chunks for play back at the vehicle, wherein the array comprises a first dimension that is defined by mixer channels and a second dimension that is defined by different audio tracks that are created from the one or more sections and the one or more stems; and select a particular one of the different audio tracks based upon a particular input variable from one or more vehicle sensors.
Clause 11. A computer-implemented method for dynamic chunking for sounds from automotive inputs at a vehicle, executed on one or more processors, the computer-implemented method comprises: receiving a digital audio file for a particular song; processing the digital audio file into a plurality of stems and sections, wherein: each stem represents a separate component or element of a song, and each section comprises a continuous portion of the song; number the sections in a priority sequence; associating the stems from the sections to input variables from one or more vehicle sensors; and generating a digital data packet that includes one or more stems, one or more sections, and associations to input variables from one or more vehicle sensors.
Clause 12. The computer-implemented method as recited in clause 11, wherein processing the digital audio file into a plurality of stems and sections further comprises: generating a waveform from the digital audio file; and analyzing the waveform to identify sections based on changes in components of the waveform.
Clause 13. The computer-implemented method as recited in clause 11, further comprising: assigning an energy score to each section and each stem based on frequency information within each section and each stem.
Clause 14. The computer-implemented method as recited in clause 13, wherein: numbering the sections in the priority sequence is based on the energy score.
Clause 15. The computer-implemented method as recited in clause 11, further comprising: playing a first stem from a first section of the particular song at the same time as a second stem from a second section of the particular song.
Clause 16. The computer-implemented method as recited in clause 15, wherein playing the first stem from the first section of the particular song at the same time as the second stem from the second section of the particular song is based upon the second stem being associated with a particular vehicle sensor that is not associated with any stems within the first section of the particular song.
Clause 17. The computer-implemented method as recited in clause 11, wherein the digital data packet does not include all of the sections and stems from the digital audio file.
Clause 18. The computer-implemented method as recited in clause 11, wherein the digital data packet is cached at the vehicle.
Clause 19. The computer-implemented method as recited in clause 11, wherein the digital data packet comprises one or more sections with particular priorities.
Clause 20. The computer-implemented method as recited in clause 11, wherein generating the digital data packet that includes one or more stems, one or more sections, and associations to input variables from one or more vehicle sensors further comprises: creating an array of potential audio chunks for play back at the vehicle, wherein the array comprises a first dimension that is defined by mixer channels and a second dimension that is defined by different audio tracks that are created from the one or more sections and the one or more stems; and selecting a particular one of the different audio tracks based upon a particular input variable from one or more vehicle sensors.

### IX. Example Structures and Computer Hardware

In at least one embodiment, the computer hardware for the systems described above may be integrated within the Original Equipment Manufacturer (OEM) multimedia center provided with the vehicle. Additionally or alternatively, the described systems may be added to the vehicle after purchase through a wholly new after-market multimedia center and/or through a plug-in device. For example, in at least one embodiment, a user may be able to plug a standalone device into their vehicle to gain the above-described features. For example, the standalone device may be plugged into a USB port within the vehicle. Additionally or alternatively, the standalone device may by plugged into the Onboard Diagnostic System (e.g., OBDII) to gather data about the vehicle sensors to be fed into the sensor API 150 within the standalone device.

Further, in at least one embodiment, the onboard device may comprise an internal inertial measurement unit (IMU) that is capable of inferring at least a portion of the sensor readings from the vehicle. For example, the IMU may detect the turning and acceleration of the car. Similarly, the IMU may detect vibrations through the suspension. The IMU may feed into the sensor API 150 as if its readings were being received from the vehicle sensors. The onboard device may then provide a soundscape through the USB port or through some other means (such as Bluetooth) to the multimedia system within the car. Accordingly, disclosure embodiments comprise built-in systems and standalone devices that are able to retrofit a vehicle to include the described functionality.

Further, the methods may be practiced by a computer system including one or more processors and computer-readable media such as computer memory. In particular, the computer memory may store computer-executable instructions that when executed by one or more processors cause various functions to be performed, such as the acts recited in the embodiments.

Computing system functionality can be enhanced by a computing systems'ability to be interconnected to other computing systems via network connections. Network connections may include, but are not limited to, connections via wired or wireless Ethernet, cellular connections, or even computer to computer connections through serial, parallel, USB, or other connections. The connections allow a computing system to access services at other computing systems and to quickly and efficiently receive application data from other computing systems.

Interconnection of computing systems has facilitated distributed computing systems, such as so-called “cloud” computing systems. In this description, “cloud computing” may be systems or resources for enabling ubiquitous, convenient, on-demand network access to a shared pool of configurable computing resources (e.g., networks, servers, storage, applications, services, etc.) that can be provisioned and released with reduced management effort or service provider interaction. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Cloud and remote based service applications are prevalent. Such applications are hosted on public and private remote systems such as clouds and usually offer a set of web-based services for communicating back and forth with clients.

Many computers are intended to be used by direct user interaction with the computer. As such, computers have input hardware and software user interfaces to facilitate user interaction. For example, a modern general-purpose computer may include a keyboard, mouse, touchpad, camera, etc. for allowing a user to input data into the computer. In addition, various software user interfaces may be available.

Examples of software user interfaces include graphical user interfaces, text command line-based user interface, function key or hot key user interfaces, and the like.

Disclosed embodiments may comprise or utilize a special purpose or general-purpose computer including computer hardware, as discussed in greater detail below. Disclosed embodiments also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer-readable storage media and transmission computer-readable media. In all cases, computer-readable storage media and transmission computer-readable media are both directed towards non-transitory media.

Physical computer-readable storage media includes RAM, ROM, EEPROM, CD-ROM or other optical disk storage (such as CDs, DVDs, etc.), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry program code in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer system for dynamic chunking for sounds from automotive inputs at a vehicle, comprising:
one or more processors; and
one or more computer-readable media having stored thereon executable instructions that when executed by the one or more processors configure the computer system to:
receive a digital audio file for a particular song;
process the digital audio file into a plurality of stems and sections, wherein:
each stem represents a separate component or element of a song, and
each section comprises a continuous portion of the song;
number the sections in a priority sequence;
associate one or more stems from one or more sections to input variables from one or more vehicle sensors; and
generate a digital data packet that includes at least portions one or more stems and at least portions one or more sections.

2. The computer system as recited in claim 1, wherein processing the digital audio file into a plurality of stems and sections includes instructions that are executable to configure the computer system to:
generate a waveform from the digital audio file; and
analyze the waveform to identify sections based on changes in components of the waveform.

3. The computer system as recited in claim 1, wherein the executable instructions include instructions that are executable to configure the computer system to:
assign an energy score to each section and each stem based on frequency information within each section and each stem.

4. The computer system as recited in claim 3, wherein:
numbering the sections in the priority sequence is based on the energy score.

5. The computer system as recited in claim 1, wherein the executable instructions include instructions that are executable to configure the computer system to:
play a first stem from a first section of the particular song at the same time as a second stem from a second section of the particular song.

6. The computer system as recited in claim 5, wherein playing the first stem from the first section of the particular song at the same time as the second stem from the second section of the particular song is based upon the second stem being associated with a particular vehicle sensor that is not associated with any stems within the first section of the particular song.

7. The computer system as recited in claim 1, wherein the digital data packet does not include all of the sections and stems from the digital audio file.

8. The computer system as recited in claim 7, wherein the digital data packet is cached at the vehicle.

9. The computer system as recited in claim 7, wherein the digital data packet comprises one or more sections with particular priorities.

10. The computer system as recited in claim 1, wherein generating the digital data packet that includes at least portions one or more stems and at least portions one or more sections includes instructions that are executable to configure the computer system to:
create an array of potential audio chunks for play back at the vehicle, wherein the array comprises a first dimension that is defined by mixer channels and a second dimension that is defined by different audio tracks that are created from the one or more sections and the one or more stems.

11. A computer-implemented method for dynamic chunking for sounds from automotive inputs at a vehicle, executed on one or more processors, the computer-implemented method comprises:
receiving a digital audio file for a particular song;
processing the digital audio file into a plurality of stems and sections, wherein:
each stem represents a separate component or element of a song, and
each section comprises a continuous portion of the song;
number the sections in a priority sequence;
associating one or more stems from one or more sections to input variables from one or more vehicle sensors; and
generating a digital data packet that includes at least portions of one or more stems and at least portions one or more sections.

12. The computer-implemented method as recited in claim 11, wherein processing the digital audio file into a plurality of stems and sections further comprises:
generating a waveform from the digital audio file; and
analyzing the waveform to identify sections based on changes in components of the waveform.

13. The computer-implemented method as recited in claim 11, further comprising:
assigning an energy score to each section and each stem based on frequency information within each section and each stem.

14. The computer-implemented method as recited in claim 13, wherein:
numbering the sections in the priority sequence is based on the energy score.

15. The computer-implemented method as recited in claim 11, further comprising:
playing a first stem from a first section of the particular song at the same time as a second stem from a second section of the particular song.

16. The computer-implemented method as recited in claim 15, wherein playing the first stem from the first section of the particular song at the same time as the second stem from the second section of the particular song is based upon the second stem being associated with a particular vehicle sensor that is not associated with any stems within the first section of the particular song.

17. The computer-implemented method as recited in claim 11, wherein the digital data packet does not include all of the sections and stems from the digital audio file.

18. The computer-implemented method as recited in claim 11, wherein the digital data packet is cached at the vehicle.

19. The computer-implemented method as recited in claim 11, wherein the digital data packet comprises one or more sections with particular priorities.

20. The computer-implemented method as recited in claim 11, wherein generating the digital data packet that includes at least portions one or more stems and at least portions one or more sections further comprises:
creating an array of potential audio chunks for play back at the vehicle, wherein the array comprises a first dimension that is defined by mixer channels and a second dimension that is defined by different audio tracks that are created from the one or more sections and the one or more stems.
